(19) United States
(12) Patent Application Publication
(10) Pub. No.: US 2025/0268789 A1
(43) Pub. Date: Aug. 28, 2025

(54) PILL ORGANIZER

(71) Applicant: E-LINK PLASTIC & METAL INDUSTRIAL CO., LTD., New Taipei City (TW)

(72) Inventor: Pin-Yang Chang, New Taipei City (TW)

(73) Assignee: E-LINK PLASTIC & METAL INDUSTRIAL CO., LTD., New Taipei City (TW)

(21) Appl. No.: 18/586,402

(22) Filed: Feb. 23, 2024

(51) Int. Cl. A61J 1/03

(52) U.S. Cl. CPC A61J 1/03

(57) ABSTRACT

A pill organizer has a first shell, a second shell, a tenon, and an inner box in order from outside to inside. The second shell has an accommodation space. The inner box has a dent and a cavity. The accommodation space corresponds to the dent in location. The tenon is moved between the accommodation space and the dent by gravity. When the pill organizer is in a normal state, the cavity is upwards. The tenon is in the accommodation space and not in the dent. When the pill organizer is in an inverted state, the cavity is downwards. The tenon is in the accommodation space and the dent at the same time. Therefore, the inner box can be pulled out in the normal state, while the inner box is blocked by the tenon and cannot be pulled out in the inverted state.

### TECHNICAL FIELD

The present invention relates to a pill organizer, especially to a pill organizer that can prevent inadvertent opening in an inverted state.

### BACKGROUND

To lighten luggage to go or for ease in identifying medication taken each time, there are a variety of pill organizers on the market for users to pack medication or health care products according to their needs. A conventional pill organizer may have seal strips mounted at the opening of the pill organizer, to keep the pill organizer closed tightly and protects the medication or the health care products from moisture.

However, if a user does not notice the direction of the pill organizer and then opens the pill organizer in an inverted state, the contents will spill out of the pill organizer, and causing inconvenience to the user.

To overcome the shortcomings, the present invention provides a pill organizer to mitigate or obviate the aforementioned problems.

### SUMMARY

The main objective of the present invention is to provide a pill organizer. The pill organizer can be in a normal state or in an inverted state. When the pill organizer is in the normal state, the pill organizer can be opened. When the pill organizer is in the inverted state, the pill organizer cannot be opened.

The pill organizer has a casing, an inner box, and a tenon. The casing comprises an accommodation space. The inner box is separably mounted in the casing and comprises a cavity and a dent. The cavity is formed on a side of the inner box. The dent is formed on another side of the inner box. The cavity is opposite to the dent in location. The dent right faces towards the accommodation space. The tenon is movably mounted in the accommodation space.

When the pill organizer is in the normal state, the cavity faces upwards and the dent faces downwards. The tenon is located in the accommodation space and not in the dent. When the pill organizer is in the inverted state, the cavity faces downwards and the dent faces upwards. The tenon is located in the accommodation space and the dent at the same time.

The benefit of the present invention is that the tenon is moved by the gravity. When the pill organizer is in the normal state, the tenon is only located in the accommodation space. The inner box can be pulled out. When the pill organizer is in the inverted state, the tenon is located in both the accommodation space and the dent at the same time. The inner box cannot be pulled out. Therefore, even if the front and the back of the pill organizer are not visually distinguishable, or even if the user fails to notice the state of the pill organizer during use, the pill organizer cannot be opened in the inverted state. This prevents the contents spilling out of the pill organizer.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a pill organizer in accordance with the first embodiment of the present invention;

FIG. 2 is an exploded view of the pill organizer in FIG. 1;

FIG. 3 is an exploded view of the pill organizer in FIG. 1, viewed from another angle;

FIG. 4 is a sectional view of the pill organizer in FIG. 1, shown in the normal state;

FIG. 5 is a sectional view of the pill organizer in FIG. 1, shown in the inverted state;

FIG. 6 is a sectional view of the second embodiment of the pill organizer, shown in the normal state; and

FIG. 7 is a sectional view of the pill organizer in FIG. 6, shown in the inverted state.

### DETAILED DESCRIPTION

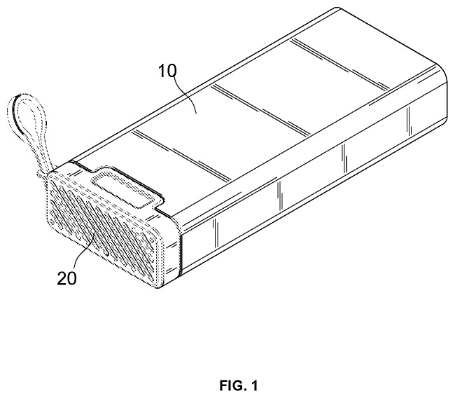

With reference to FIG. 1 to FIG. 3 first, a pill organizer in accordance with the present invention can be in a normal state or in an inverted state. In the first embodiment, the pill organizer comprises a casing 10, an inner box 20, a seal strip 30, and a tenon 40.

The casing 10 comprises an opening. The inner box 20 can be mounted in the casing 10 through the opening or can be pulled out through the opening. In this embodiment, the casing 10 comprises a first shell 11 and a second shell 12. The second shell 12 is securely mounted in the first shell 11. The inner box 20 can move in the second shell 12. In this embodiment, the first shell 11 and the second shell 12 are fixed to each other and form the casing 10.

In addition to a storage space for the inner box 20, the casing 10 also comprises an accommodation space 13 in this embodiment. The tenon 40 is movably mounted in the accommodation space 13. Precisely, the accommodation space 13 is formed through the second shell 12. A first hole 131 and a second hole 132 are respectively formed at two opposite ends of the accommodation space 13. The first hole 131 is close to the first shell 11, and the second hole 132 is close to the inner box 20. A cross-section of the first hole 131 is larger than a cross-section of the second hole 132.

In this embodiment, the inner box 20 comprises a cavity 21 and a dent 22. The cavity 21 and the dent 22 are respectively formed on two opposite faces of the inner box 20. The cavity 21 is applied to store medication and can be partitioned into multiple compartments. In this embodiment, the cavity 21 comprises three compartments, so three kinds of medications can be stored respectively.

The dent 22 faces right towards the accommodation space 13 of the second shell 12. The dent 22 comprises a third hole 220. When the inner box 20 is located in the casing 10, the third hole 220 is aligned with the second hole 132. The second hole 132 and the third hole 220 can be the same in cross-sectional shape and size.

The seal strip 30 surrounds and is mounted on a surface of the inner box 20. The seal strip 30 contacts an inner surface of the casing 10. When the inner box 20 is mounted in the casing 10, the seal strip 30 fitly contacts the inner surface of the casing 10 and is located on the opening of the casing 10. The seal strip 30 is closer to the outside of the pill organizer than the cavity 21. Therefore, the seal strip 30 can prevent moisture permeating into the cavity 21 through the opening of the casing 10.

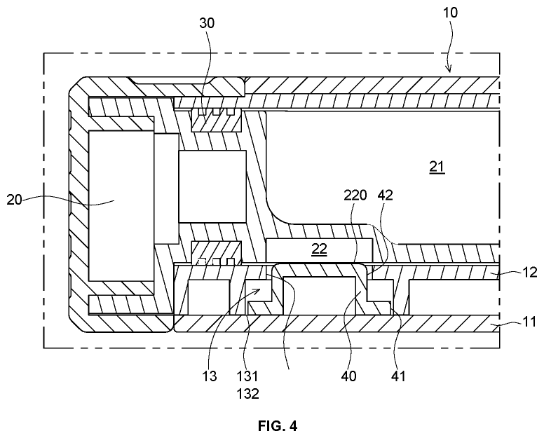

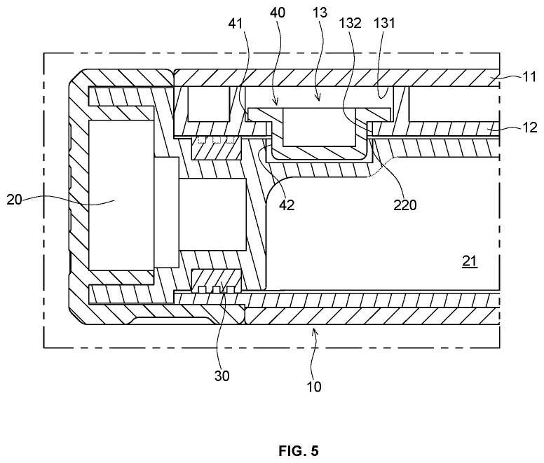

With reference to FIG. 4 and FIG. 5, the tenon 40 is moved between the second shell 12 and the inner box 20 by gravity. Precisely, the tenon 40 moves between the dent 22 and the accommodation space 13. The tenon 40 comprises a first tip 41 and a second tip 42. The first tip 41 is close to the first shell 11. The second tip 42 is opposite to the first tip 41 and is close to the inner box 20. A cross-section of the first tip 41 is larger than a cross-section of the second tip 42. The cross-section of the first tip 41 is smaller than the cross-section of the first hole 131 and is larger than the cross-section of the second hole 132. The cross-section of the second tip 42 is smaller than the cross-section of the second hole 132. In other words, from the largest to the smallest, the order is the cross-section of the first hole 131, the cross-section of the first tip 41, and the cross-section of the second hole 132, and the cross-section of second tip 42 the is the smallest.

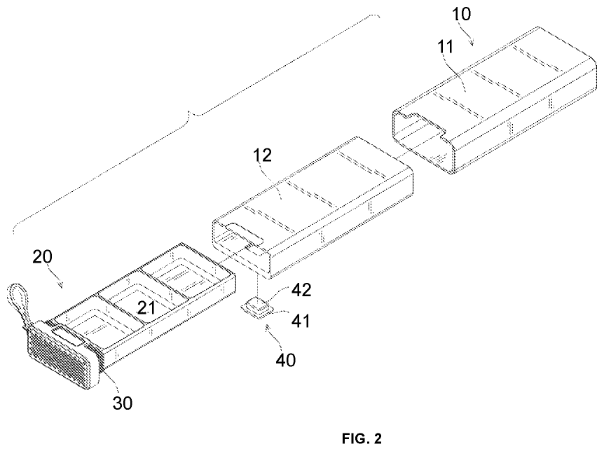

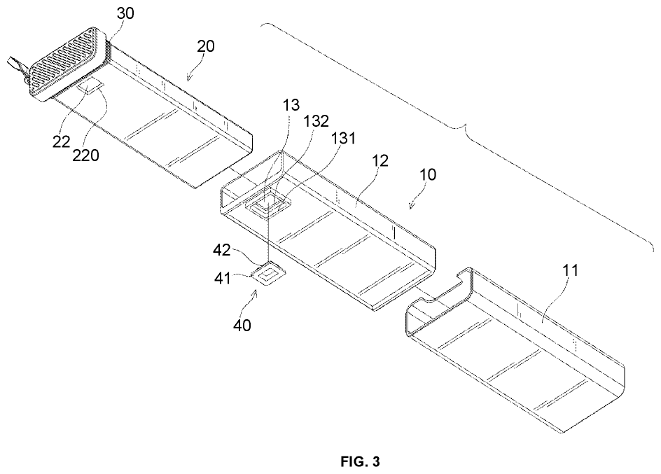

With reference to FIG. 2 and FIG. 3, in the first embodiment, the first shell 11 and the second shell 12 are two different components. During manufacture, the tenon 40 is placed into the accommodation space 13 of the second shell 12, and then the second shell 12 is inserted into the first shell 11. Therefore, with the relationship of the cross-sectional sizes mentioned above, the tenon 40 can be easily mounted in the accommodation space 13 of the second shell 12 without being separated from the accommodation space 13.

With reference to FIG. 4 and FIG. 5 again, when the pill organizer is in the normal state, the cavity 21 faces upwards and the dent 22 faces downwards. The tenon 40 will fall into the accommodation space 13 below due to gravity and will not be located in the dent 22. When the pill organizer is in the inverted state, the cavity 21 faces downwards and the dent 22 faces upwards. The cross-section of the first tip 41 of the tenon 40 is larger than the cross-section of the second hole 132 of the accommodation space 13, such that the tenon 40 will not be completely separated from the accommodation space 13. However, a part of the tenon 40 (i.e., the second tip 42) will fall into the dent 22. The tenon 40 will be located in the accommodation space 13 and the dent 22. In other words, the tenon 40 is located between the inner box 20 and the second shell 12 at the same time. Therefore, when the user wants to pull out the inner box 20, the inner box 20 will be blocked by the protruding tenon 40 and cannot be pulled out from the casing 10.

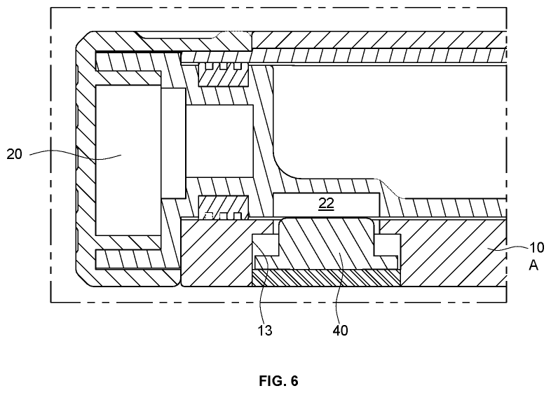

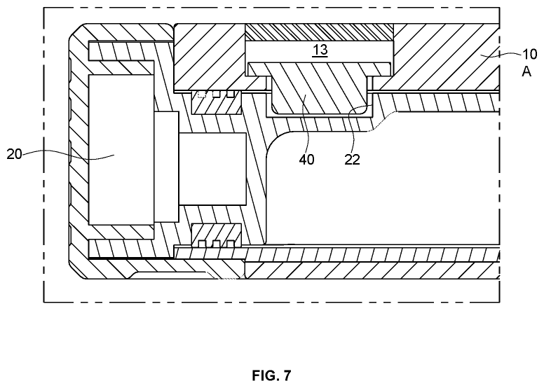

With reference to FIG. 6 and FIG. 7, the second embodiment is similar to the first embodiment. The difference is that the first shell 11 and the second shell 12 are an integrally formed casing 10A. In other words, the first shell 11 and the second shell 12 can be considered as one entity. In the second embodiment, the casing 10A also comprises an accommodation space 13A and the inner box 20 also comprises the dent 22. The tenon 40 can move between the accommodation space 13A and the dent 22. Another difference is that the accommodation space 13A is through the casing 10A. Therefore, the second embodiment also comprises a cover 50A. The cover 50A is securely threaded or embedded on an opening of the accommodation space 13. Said opening of the accommodation space 13 is located on an outer surface of the casing 10A. Therefore, the tenon 40 can be enclosed into the accommodation space 13A.

The benefit of the present invention is that the tenon 40 is moved by the gravity. When the pill organizer is in the normal state, the tenon 40 is only located in the accommodation space 13. The inner box 20 can be pulled out. When the pill organizer is in the inverted state, the tenon 40 is located in both the accommodation space 13 and the dent 22 at the same time. The inner box 20 cannot be pulled out. Therefore, even if the front and the back of the pill organizer are not visually distinguishable, or even if the user fails to notice the state of the pill organizer during use, the pill organizer cannot be opened in the inverted state. It prevents the contents spilling out of the pill organizer.

Even though numerous characteristics and advantages of the present invention have been set forth in the foregoing description, together with details of the structure and features of the invention, the disclosure is illustrative only. Changes may be made in the details, especially in matters of shape, size, and arrangement of parts within the principles of the invention to the full extent indicated by the broad general meaning of the terms in which the appended claims are expressed.

What is claimed is:

1. A pill organizer comprising:
a casing comprising an accommodation space;
an inner box separatably mounted in the casing; the inner box comprising:
a cavity formed on a side of the inner box; and
a dent formed on another side of the inner box and being opposite to the cavity; the dent facing towards the accommodation space; and
a tenon movably mounted in the accommodation space;
wherein when the pill organizer is in a normal state, the cavity is upward and the dent is downward; the tenon is located in the accommodation space and out of the dent;
when the pill organizer is in an inverted state, the cavity faces downward and the dent faces upward; the tenon is located in the accommodation space and the dent at the same time.

2. The pill organizer as claimed in claim 1, wherein:
the casing comprises an opening, the inner box being capable of passing through the opening;
the pill organizer further comprises a seal strip; the seal strip being securely mounted on the inner box and surrounding the inner box; and
when the inner box is mounted in the casing, the seal strip hermetically fits the casing and the seal strip is closer to the opening than the cavity.

3. The pill organizer as claimed in claim 1, wherein the casing comprises:
a first shell; and
a second shell securely mounted in the first shell; the accommodation space formed through the second shell.

4. The pill organizer as claimed in claim 2, wherein the casing comprises:
a first shell; and
a second shell securely mounted in the first shell; the accommodation space formed through the second shell.

5. The pill organizer as claimed in claim 3, wherein:
the accommodation space comprises:
a first hole being near the first shell; and
a second hole being opposite to the first hole and near the inner box;
the tenon comprises:
a first tip being a tip near to the first shell; and
a second tip being opposite to the first tip and a tip near to the inner box;
the dent of the inner box comprises a third hole; the third hole configured to aligned with the second hole;
wherein the first hole is bigger than the second hole, and the second hole and the third hole are of the same size; a cross-section of the first tip is bigger than a cross-section of the second tip; the cross-section of the first tip is smaller than the first hole and bigger than the second hole; the cross-section of the second tip is smaller than the second hole.

6. The pill organizer as claimed in claim 4, wherein:
the accommodation space comprises:
a first hole being near the first shell; and
a second hole being opposite to the first hole and near the inner box;
the tenon comprises:
a first tip being a tip near to the first shell; and
a second tip being opposite to the first tip and a tip near to the inner box;
the dent of the inner box comprises a third hole; the third hole configured to aligned with the second hole;
wherein the first hole is bigger than the second hole, and the second hole and the third hole are of the same size; a cross-section of the first tip is bigger than a cross-section of the second tip; the cross-section of the first tip is smaller than the first hole and bigger than the second hole; the cross-section of the second tip is smaller than the second hole.

7. The pill organizer as claimed in claim 3, wherein the first shell and the second shell are integrally formed.

8. The pill organizer as claimed in claim 6, wherein the first shell and the second shell are integrally formed.

9. The pill organizer as claimed in claim 1, wherein the cavity comprises multiple compartments.

10. The pill organizer as claimed in claim 8, wherein the cavity comprises multiple compartments.
